(19) United States
(12) Patent Application Publication
(10) Pub. No.: US 2012/0098772 A1
(43) Pub. Date: Apr. 26, 2012

(54) METHOD AND APPARATUS FOR RECOGNIZING A GESTURE IN A DISPLAY

(75) Inventors: Dong-jin EUN, Seoul (KR); Taik-heon Rhee, Seoul (KR); Sung-bin Kuk, Suwon-si (KR); Yeo-jun Yoon, Suwon-si (KR); Pil-seung Yang, Suwon-si (KR)

(73) Assignee: Samsung Electronics Co., Ltd.

(21) Appl. No.: 13/277,743

(22) Filed: Oct. 20, 2011

(30) Foreign Application Priority Data
Oct. 20, 2010 (KR) 10-2010-0102509

(51) Int. Cl. G06F 3/041

(52) U.S. Cl. 345/173

(57) ABSTRACT

A method of recognizing a gesture in a touch-based display, the method includes receiving a touch input in the display, recognizing a gesture input associated with the touch input; and performing a function assigned to the recognized gesture input.

### PRIORITY

This application claims priority to Korean Patent Application No. 10-2010-0102509, filed on Oct. 20, 2010, in the Korean Intellectual Property Office, the contents of which are incorporated herein by reference.

### BACKGROUND OF THE INVENTION

1. Field of the Invention

The present invention relates generally to a method and an apparatus for recognizing a gesture in a display, and more particularly, to a method and an apparatus for recognizing a touch gesture input in a touch input display, and for recognizing a gesture in the display which performs a function by using a gesture.

2. Description of the Related Art

Electronic blackboards have recently become more widespread in places such as schools. An electronic blackboard is a conductive, flat plate board that may be written on with an electronic pen.

Electronic blackboards are basically classified into 3 types: a tablet-type Liquid Crystal Display (LCD) monitor electronic blackboard, an electronic blackboard of a general whiteboard type, and a projection TV-type electronic blackboard having a built-in beam projector. In addition, according to a writing method, electronic blackboards are also classified into an electronic blackboard that may be written on by using both hand and an electronic pen, or by using only an electronic pen.

Touchscreen technologies have become widely used for a Large Format Display (LFD) of an electronic blackboard type. A method of clicking on a button or a menu at a corner of an electronic blackboard is commonly used for changing functions, such as for changing a displayed text color or loading a new screen while performing a function such as writing in an electronic blackboard. There is a need in the art for an improved method for touchscreen displays, which method would invoke gesture recognition.

### SUMMARY OF THE INVENTION

Accordingly, an aspect of the present invention is to provide a method and an apparatus for recognizing a gesture in a display that allows a touch input, by which a gesture distinguishable from writing is recognized without having to click on a button or a menu assigned to a portion of a screen.

According to an aspect of the present invention, a method of recognizing a gesture in a touch-based display is provided. The method includes recognizing a gesture input performed by touching with an input unit in the display, and performing a function assigned to the recognized gesture.

According to another aspect of the present invention, a display apparatus is provided. The display apparatus includes a display unit that receives a touch input, a gesture recognition unit that recognizes a gesture input performed by touching with an input unit in the display unit, and a control unit for performing a function assigned to the recognized gesture.

### BRIEF DESCRIPTION OF THE DRAWINGS

The above and other aspects, features and advantages of the present invention will become more apparent by describing in detail certain embodiments thereof with reference to the attached drawings in which:

FIG. 1 illustrates a method of recognizing a gesture in a display apparatus, according to an embodiment of the present invention;

FIGS. 2A through 2D illustrate examples of a first gesture and a second gesture according to an embodiment of the present invention;

FIGS. 3A through 3C illustrate a scenario for recognizing a gesture according to an embodiment of the present invention and performing a function by using a gesture; and

FIG. 4 illustrates a display apparatus according to an embodiment of the present invention.

### DETAILED DESCRIPTION OF THE INVENTION

Various embodiments of the present invention are described in detail as follows with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for the sake of clarity and conciseness.

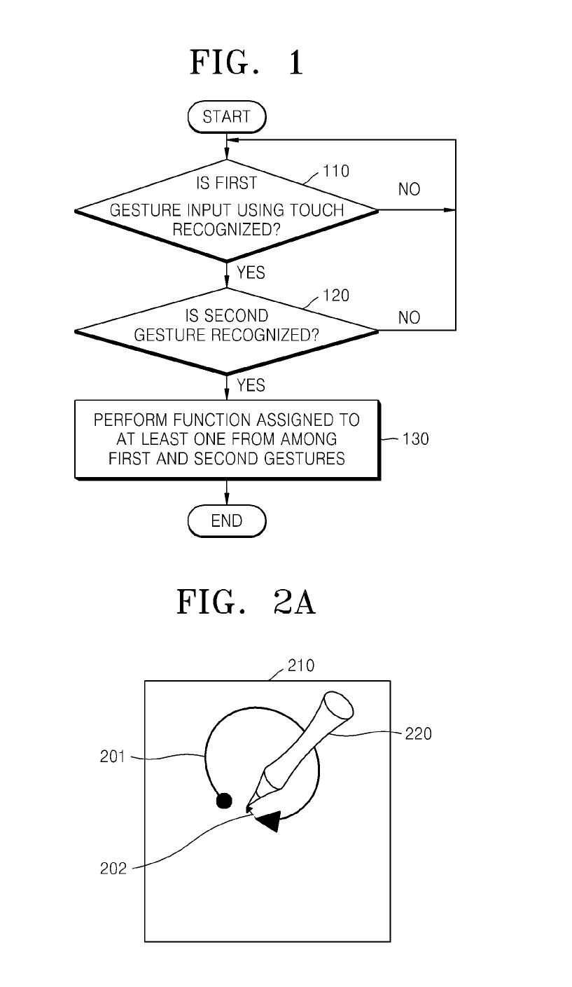

FIG. 1 illustrates a method of recognizing a gesture in a display apparatus, according to an embodiment of the present invention.

Referring to FIG. 1, in operation 110, the display apparatus recognizes a first gesture performed by touching. The display apparatus includes a display that receives a touch input, and recognizes an operation according to the touch input as a gesture. For example, the display apparatus recognizes and regards an operation, such as a user drawing a circle on the display by touch, as a gesture. The display apparatus receives both a writing input and a gesture input by using an input unit such as a stylus or a finger. When the display apparatus is an electronic blackboard, if there is an input to the display, the display apparatus determines whether the input is a writing input or a gesture input. The display apparatus compares the input with a predefined gesture. As a result of the comparison, when it is determined that the input corresponds to the predefined gesture, the display apparatus recognizes the input as a gesture. If the input does not correspond to the predefined gesture, the display apparatus recognizes the input as a writing operation.

In operation 120, the display apparatus recognizes a second gesture after recognizing the first gesture. The second gesture is for defining the first gesture as a gesture. Alternatively, the second gesture is separate from the first gesture, and is enclosed within a period of time after the first gesture, which period of time frame may be set by a manufacturer of the display apparatus.

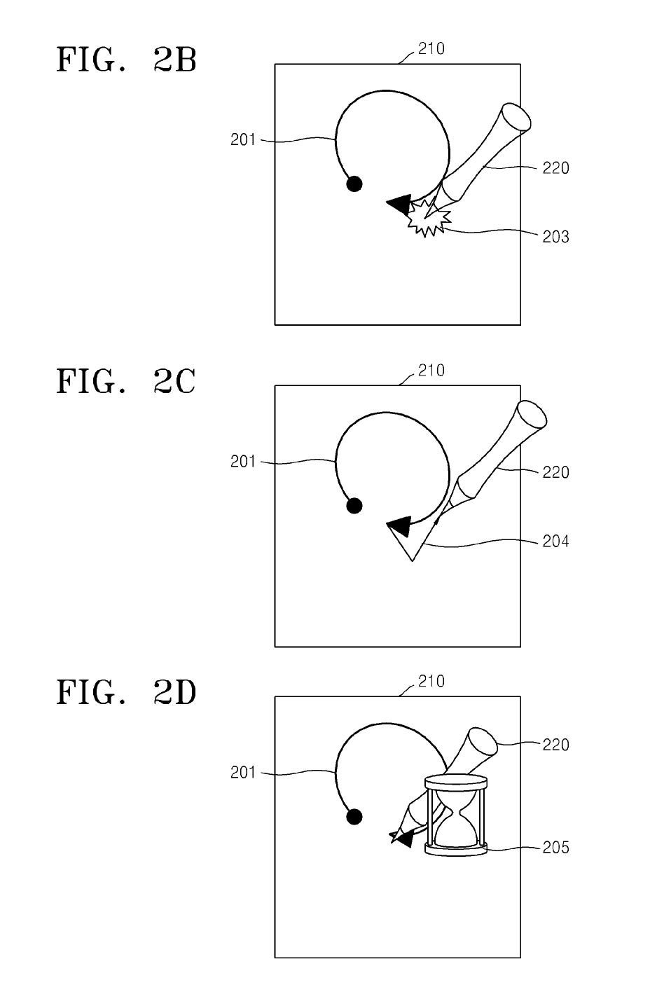

FIGS. 2A through 2D illustrate examples of a first gesture and a second gesture according to an embodiment of the present invention.

Referring to FIG. 2A, a first gesture 201 is for drawing a circle on a display 210 by using an input unit 220, and a second gesture 202 is for detaching the input unit 220 from the display 210 immediately after the first gesture 201.

Referring to FIG. 2B, a first gesture 201 is for drawing a circle in a display 210 by using an input unit 220, and a second gesture 203 is for inputting a tap in the display 210 after the first gesture 201.

Referring to FIG. 2C, a first gesture 201 is for drawing a circle in a display 210 by using an input unit 220, after which a second gesture 204 is separately performed.

Referring to FIG. 2D, a first gesture 201 is for drawing a circle in a display 210 by using an input unit 220, and a second gesture 205 is for placing the input unit 220 in the display 210 in a standby state for a period of time after the first gesture 201.

Recognition errors are reduced when placing the input unit 220 in the display 210 in the standby state instead of detaching the input unit 220 from the display 210 as the second gesture, although usability may decrease. However, recognition errors may increase when detaching the input unit 220 from the display 210 as the second gesture instead of placing the input unit 220 in the display 210 in the standby state, although usability may improve. The manufacturer of the display apparatus determines whether the usability or error recognition will be enhanced.

Referring back to FIG. 1, in operation 130, the display apparatus performs a function assigned to at least one of the first and second gestures. If the second gesture only defines the first gesture, a function corresponding to the gestures may be assigned only to the first gesture. For example, when a function of opening a drawing is assigned to a first gesture for drawing a circle, when the display apparatus recognizes the first gesture, and a second gesture for defining the first gesture, such as a tap input, the display apparatus opens a drawing. However, a function may alternatively be assigned to the second gesture by itself.

If both the first and second gestures are recognized, a function may be assigned so that the display apparatus performs only one function. For example, if the display apparatus recognizes a gesture for drawing a circle and a gesture for a tap input, which occurs after the first gesture, the display apparatus opens a drawing. If the display apparatus recognizes a gesture for drawing a circle and a gesture for maintaining an input unit in a stand-by state for a period of time, the display apparatus performs a highlighting function.

The display apparatus may also perform a function assigned to a gesture recognized at a location of a gesture input on the display.

As described above, if the display apparatus recognizes two gestures, i.e., the first and second gestures, the display apparatus may perform a function assigned to the gestures. However, even when a display apparatus recognizes only one gesture, the display apparatus may also perform a function assigned to the gesture.

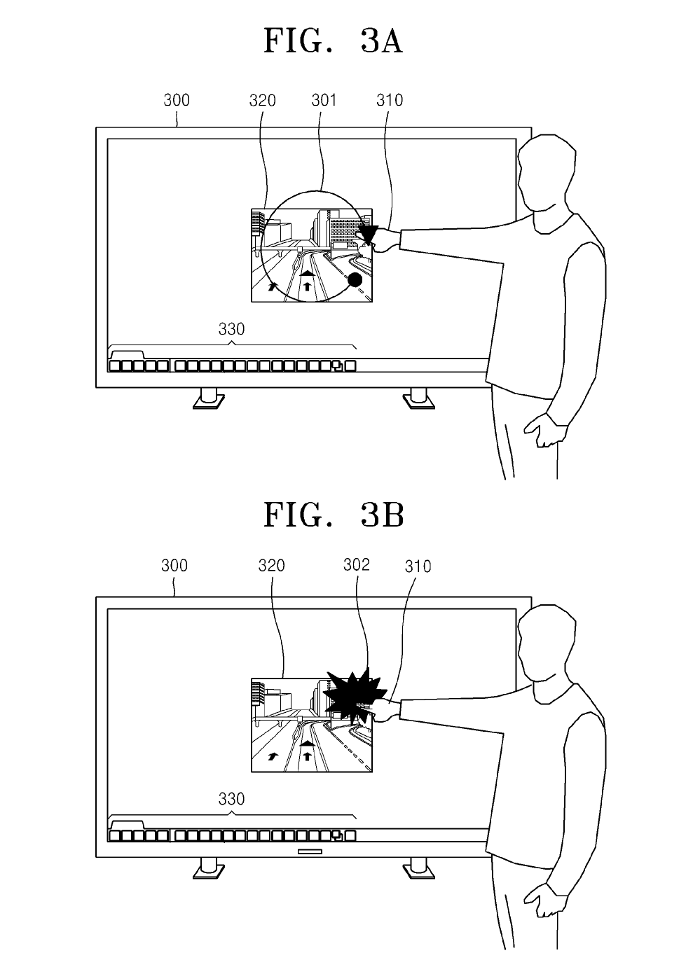

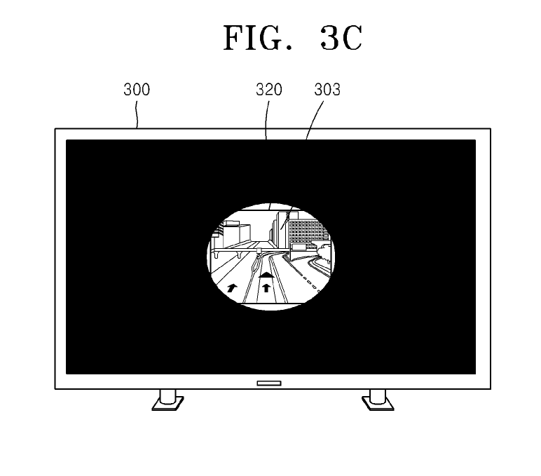

FIGS. 3A through 3C illustrate a scenario for recognizing a gesture according to an embodiment of the present invention, and for performing a function by using a gesture.

Referring to FIG. 3A, an electronic blackboard 300, which is a display apparatus, includes a menu button unit 330 for performing a function. A user of the electronic blackboard 300 may perform a function by touching one of the buttons of the menu button unit 330. The user performs a first gesture 301 by using a finger 310 as an input unit, near a region at which an image 320 is displayed.

Referring to FIG. 3B, after the operation illustrated in FIG. 3A, the user performs a second gesture 302, which is a tap input, by using the finger 310 as the input unit.

Referring to FIG. 3C, after the operation illustrated in FIG. 3B, the electronic blackboard 300 performs a function mapped to the first gesture 301 and/or the second gesture 302. FIG. 3C illustrates a result of performing the function of highlighting an operation region of the first gesture 301.

As illustrated in FIGS. 3A through 3C, the user may perform a menu function of the electronic blackboard 300 by using a gesture, without having to select the menu button unit 330.

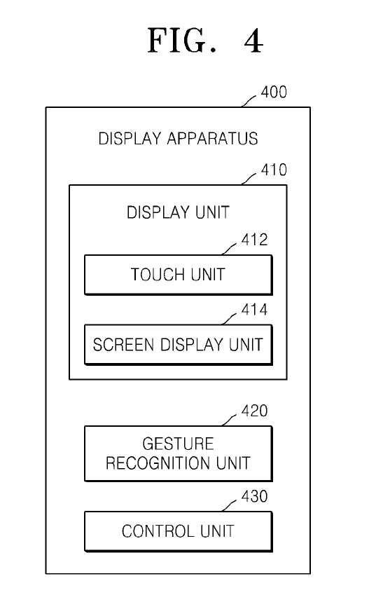

FIG. 4 illustrates a display apparatus 400 according to an embodiment of the present invention.

Referring to FIG. 4, the display apparatus 400 includes a display unit 410, a gesture recognition unit 420, and a control unit 430. The display unit 410 includes a touch unit 412 and a screen display unit 414.

The display apparatus 400 allows a touch input. For example, the display apparatus 400 may be an electronic blackboard that receives both a writing input by using handwriting and a gesture input. However, the display apparatus 400 is not limited to the electronic blackboard, and examples of the display apparatus 400 may also include an apparatus that allows touchscreen drawing, such as a tablet Personal Computer (PC) or a mobile device.

The touch unit 412 of the display unit 410 receives an input of a location touched by using an input unit such as a finger or a stylus. A representative example of the touch unit 412 may be a touchscreen panel, which is installed at a front of the screen display unit 414 of an electronic apparatus such as a Personal Computer (PC), a notebook computer, or a Portable Media Player (PMP), and inputs a specific command or data to the electronic apparatus by, for example, making contact or drawing a character or a picture with an input unit. Methods of driving a general touchscreen panel include the resistive and capacitive overlay methods.

A touchscreen panel of a capacitive overlay type includes a lower electrode and an upper electrode which are patterned in an orthogonal direction with each other and are separated from each other by a dielectric material. The touchscreen panel of a capacitive overlay type recognizes a change, due to a touch, in an electrostatic capacitance at an intersection of the lower and upper electrodes. A touchscreen panel of a resistive overlay type includes lower and upper electrodes that are patterned in an orthogonal direction to each other and are separated from each other by a spacer.

The touchscreen panel of a resistive overlay type recognizes a change in a resistance caused by contact, resulting from a touch, between the lower electrode and the upper electrode. The touchscreen panel may be attached at the front of the screen display unit 414, for example, a manufactured Liquid Crystal Display (LCD) or may be integrated into the LCD. The touch unit 412 allows both a writing input and a gesture input by using an input unit such as a stylus or a finger. The screen display unit 412 of the display unit 410 displays an input such as a writing input.

The gesture recognition unit 420 recognizes a first gesture by using a touch. The gesture recognition unit 420 recognizes, as a gesture, an operation that is input by a touch. For example, the gesture recognition unit 420 recognizes and regards an operation, such as a user's drawing of a circle on a display by using a touch, as a gesture. When there is an input in the touch unit 412, the gesture recognition unit 420 determines whether the input is a writing input or a gesture input. The gesture recognition unit 420 compares an input stored in a storage unit (not shown) with a predefined gesture. As a result of the comparison, when it is determined that the input corresponds to the predefined gesture, the gesture recognition unit 420 recognizes the input as a gesture. For example, if the display apparatus 400 is an electronic blackboard, when it is determined from the comparison that the input corresponds to a predefined gesture, the gesture recognition unit 420 recognizes the input as a gesture. When the input does not correspond to the predefined gesture, the gesture recognition unit 420 recognizes the input as a writing operation.

The gesture recognition unit 420 recognizes a second gesture after recognizing the first gesture. The second gesture may be for defining the first gesture as a gesture, or may be separate from the first gesture. The second gesture should be recognized within a period of time after the first gesture, which time may be established by the display device manufacturer. Herein, a first gesture is a drawing of a circle on the touch unit 412 by using an input unit, and a second gesture is a detaching of the input unit from the touch unit 412 immediately after performing the first gesture.

According to another embodiment of the present invention, a first gesture is also drawing of a circle on the touch unit 412 by using an input unit, and a second gesture is an input of a tap on the touch unit 412 after performing the first gesture. Alternatively, a first gesture is drawing of a circle on the touch unit 412 by using an input unit, and a second gesture is a separate gesture after performing the first gesture.

A first gesture may also be drawing of a circle on the touch unit 412 by using an input unit, while a second gesture is of maintaining the input unit in the touch unit 412 in a standby state for a period of time after performing the first gesture.

Recognition errors are reduced when maintaining an input unit in a stand-by state as a second gesture instead of detaching the input unit from the touch unit 412 as a second gesture, but usability may be decreased. However, when detaching an input unit from the touch unit 412 as a second gesture instead of maintaining an input unit in a stand-by state as a second gesture, usability may be improved, but recognition errors may be increased. The manufacturer of the display apparatus determines whether the usability or error recognition will be enhanced.

The control unit 430 performs a function assigned to at least one of the first and second gestures. When the second gesture only performs a function of defining the first gesture, a function corresponding to a gesture may be assigned to only the first gesture. For example, if a function of opening a drawing is assigned to a first gesture for drawing a circle, when the gesture recognition unit 420 recognizes the first gesture, and a second gesture for defining the first gesture, such as a tap input, the control unit 430 performs the function of opening a drawing. Alternatively, a function may be assigned to the second gesture by itself.

If both first and second gestures are recognized, one function may be assigned to be performed by the control unit 430. For example, if the control unit 430 recognizes a gesture for drawing a circle as well as a gesture for a tap input, which occurs after the first gesture, the control unit 430 performs a function of opening a drawing. If the control unit 430 recognizes a gesture for drawing a circle and a gesture for maintaining an input unit in a stand-by state for a period of time, the control unit 430 performs a highlighting function.

The control unit 430 may perform a function assigned to a gesture recognized at a location of the first gesture input on the touch unit 412.

As described above, if the display apparatus 400 recognizes two gestures, i.e. the first and second gestures, the display apparatus 400 performs a function assigned to the gestures. However, even when the display apparatus 400 recognizes only one gesture, the display apparatus 400 may perform a function assigned to the gesture.

The method of recognizing a gesture in the display which allows a touch input, as described above, can also be embodied as computer readable code on a computer readable recording medium. The computer readable recording medium is any data storage device that can store data that can be thereafter read by a computer system. Examples of the computer readable recording medium include Read-Only Memory (ROM), Random-Access Memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While this invention has been particularly shown and described with reference to certain embodiments thereof, it will be understood by those of ordinary skill in the art that various changes in form and details may be made therein without departing from the spirit and scope of the invention as defined by the appended claims. The embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of recognizing a gesture in a touch-based display, the method comprising:
receiving a touch input in the display;
recognizing a gesture input associated with the touch input; and
performing a function assigned to the recognized gesture input.

2. The method of claim 1, wherein the recognizing of the gesture input comprises:
recognizing a first gesture input associated with the touch input
receiving a second touch input;
recognizing a second gesture input associated with the second touch input after recognizing the first gesture, and
wherein performing the function assigned to the recognized gesture comprises performing a function assigned to at least one of the recognized first and second gestures, after the second gesture input is recognized.

3. The method of claim 2, wherein the second gesture detaches the input unit from the display after the first gesture is performed.

4. The method of claim 2, wherein the second gesture inputs a tap in the display by using the input unit after the first gesture is performed.

5. The method of claim 2, wherein the second gesture is a gesture that is different from the first gesture, and is performed after the first gesture is performed.

6. The method of claim 2, wherein the second gesture maintains a touch in the display by using the input unit for a period of time after the first gesture is performed.

7. The method of claim 1, wherein performing the function assigned to the recognized gesture comprises:
comparing the recognized gesture with a predefined gesture; and
performing, when it is determined from the comparing that the recognized gesture corresponds to the predefined gesture, a function that matches the predefined gesture.

8. The method of claim 7, further comprising recognizing the recognized gesture as writing, when the display allows both a writing input and a gesture input by using a touch input unit, and it is determined from the comparing that the recognized gesture does not correspond to the predefined gesture.

9. The method of claim 1, wherein the function assigned to the recognized gesture is performed at a location of the gesture input to the display.

10. A display apparatus comprising:
a display unit that receives a touch input;
a gesture recognition unit that recognizes a gesture input associated with the touch input; and
a control unit for performing a function assigned to the recognized gesture input.

11. The display apparatus of claim 10, wherein the gesture recognition unit recognizes a first gesture input, and a second gesture input, and
wherein the control unit performs a function assigned to at least one from among the recognized first and second gestures.

12. The display apparatus of claim 11, wherein the second gesture detaches the input unit from the display unit, after the first gesture is performed.

13. The display apparatus of claim 11, wherein the second gesture inputs a tap in the display unit by using the input unit, after the first gesture is performed.

14. The display apparatus of claim 11, wherein the second gesture is different from the first gesture, and is performed after the first gesture is performed.

15. The display apparatus of claim 11, wherein the second gesture maintains a touch in the display unit by using the input unit for a period of time after the first gesture is performed.

16. The display apparatus of claim 10, wherein the control unit compares the recognized gesture with a predefined gesture and, when it is determined from the comparing that the recognized gesture corresponds to the predefined gesture, performs a function which matches the predefined gesture.

17. The display apparatus of claim 16, wherein the display unit receives both a writing input and a gesture input, and wherein the control unit determines from the comparing that the recognized gesture does not correspond to the predefined gesture, the control unit recognizes the recognized gesture as writing.

18. The display apparatus of claim 10, wherein the control unit performs a function assigned to the recognized gesture at a location of the gesture input in the display unit.

19. A computer readable recording medium having recorded thereon a method of recognizing a gesture in a display that receives a touch input, the method comprising:
receiving a touch input in the display;
recognizing a gesture input associated with the touch input; and
performing a function assigned to the recognized gesture input.
